(19) United States
(12) Patent Application Publication
(10) Pub. No.: US 2014/0031188 A1
(43) Pub. Date: Jan. 30, 2014

(54) METHOD AND APPARATUS FOR ERECTING PART OF A CONTAINER

(71) Applicants: Georg Rudolf Janse Van Rensburg, Somerset West (ZA); Charl Nieder-Heitmann, Somerset West (ZA)

(72) Inventors: Georg Rudolf Janse Van Rensburg, Somerset West (ZA); Charl Nieder-Heitmann, Somerset West (ZA)

(21) Appl. No.: 14/002,976

(22) PCT Filed: Feb. 28, 2012
(86) PCT No.: PCT/IB2012/050906

§ 371 Date: Oct. 16, 2013

(30) Foreign Application Priority Data
Mar. 3, 2011 (ZA) 2011/01637

(51) Int. Cl. B31B 1/78

(52) U.S. Cl. CPC B31B 1/78
USPC 493/309

(57) ABSTRACT

The invention relates to a method and apparatus for erecting part of a container, specifically containers referred to as “trays” in the art. The method includes using a mandrel to fold four walls (14, 16) of the container (12) but return side walls (16) to a slanted, lower intermediate position relative to upstanding end walls (14), so that a finger (30) can pivot to fold a pillar (24) from an end (26) of an extension (20) of the end walls (14) and retract over the side walls (16), before a pressing element (36) raises the intermediately positioned side walls (16) to upstanding positions where they are attached to the pillars.

### FIELD OF THE INVENTION

This invention relates to the folding of containers such as cartons or trays from sheet material. In particular, the invention relates to a method and apparatus for erecting part of a container to form a reinforcing brace and pillar in the corner of the container.

### BACKGROUND TO THE INVENTION

Containers that are formed from sheet material such as corrugated paperboard (or other suitable material) are used widely in the packaging and transport of goods, but the present invention relates more specifically to containers of this type, often referred to in the art as “trays” that are open on top and that are intended for the storage and transport of fresh produce, although the principles of the present invention can, of course be applied beneficially to cartons for other purposes too.

Trays of this type typically need to be stacked to make optimal use of space and they are typically provided with stacking lugs and complementary recesses for this reason and they are designed to provide sufficient support for the trays above them.

One of the methods used for providing sufficient support, is to reinforce the corners of the tray with an angled brace, to form a reinforced pillar with a triangular cross-sectional profile, in each corner of the tray.

In order to erect such a tray with braces/pillars in its corners, a blank of sheet material is cut and scored (or the like) and a mandrel pushes a part of the blank that will form a floor of the tray, between formations that cause parts of the blank that will form walls of the tray, to fold upwards relative to the floor. Tabs that extend from ends walls of the containers are then folded by fingers around legs of the mandrel to form the corner pillars and while the fingers still hold the corner pillars in place, side walls are pressed to be adhesively bonded to the pillars.

This widely used erection method holds the disadvantage that the side walls of the trays need to have a height that is lower than the pillars for at least part of their length so that those parts of the side walls can fit underneath the fingers that form the pillars and hold them in place, while the side walls are bonded to the pillars. The reduced height of the side walls causes unwanted restrictions in the graphics that need to be printed on the side walls and/or cause very substantial costs to alter printing to accommodate the reduced height of the side walls.

The present invention seeks to provide for the production of such trays wherein the side walls can have the full height of the rest of the containers, without a significant increase in the cost of producing the trays.

### SUMMARY OF THE INVENTION

According to one aspect of the present invention there is provided a method for erecting part of a container, said method comprising:
forming a blank of sheet material;
pressing a part of the blank with a mandrel between adjacent formations to form a floor of the container and upstanding walls on four sides of the floor, a first pair of said upstanding walls being on opposing sides of the floor and being folded to upright positions and the remaining second pair of said upstanding walls being folded to slanted intermediate positions that are substantially lower than upright positions;
pivoting fingers inwards along pivot paths in directions generally parallel to the floor towards inwards positions, to fold extensions on the ends of the first pair of walls to form pillars;
attaching ends of the extensions to the insides of the first pair of walls;
pivoting the fingers outwards; and
folding the second pair of walls to upright positions relative to the floor and pressing them against the outsides of the pillars.

The second pair of walls may be folded to their intermediate positions by the mandrel in a single step, or they may be folded by the mandrel to upright positions and then returned partially (e.g. through resilience of the sheet material, under gravity, by active folding, or the like) to their intermediate positions.

The ends of the extensions may be attached to the insides of the first pair of walls by pivoting arms over upper edges of the first pair of walls and pressing the ends of the extensions outwardly against the insides of the first pair of walls.

The method may include holding each pillar in position while its associated finger is in its inward position, by way of a lateral protuberance extending from an edge of the finger.

The first pair of walls may be the end walls of the container and the second pair of walls may be the side walls.

The steps of pressing the ends of the extensions against the insides of the first pair of walls and of pressing the second pair of walls against the outsides of the pillars, may include adhesively bonding these parts together, preferably using adhesive that was pre-applied to the blank.

According to another aspect of the present invention there is provided apparatus for erecting part of a container, said apparatus including:
a mandrel and adjacent formations between which a container blank can be pressed to form a floor of the container and upstanding walls on four sides of the floor, said upstanding walls including a first pair of opposing walls and a second pair of opposing walls;
fingers that are configured to pivot along pivot paths in directions generally parallel to the container floor towards inwards positions, to fold extensions on the ends of the first pair of walls to form pillars; and
press elements that are configured to fold the second pair of walls to upright positions relative to the floor and pressing them against the outsides of the pillars;
wherein said mandrel and adjacent formations are configured to fold the second pair of walls to slanted intermediate positions substantially lower than upright positions, said intermediate positions being below the pivot paths, and said fingers being configured to pivot outwards along their pivot paths to clear the second walls, before the second walls are folded to their upright position by the press elements.

Each of the fingers may have a lateral protuberance extending from an edge of the finger and being configured to hold its associated pillar in position while the finger is in its inwards position.

The apparatus may include arms that are configured to pivot over upper edges of the first pair of walls to press ends of the extensions outwardly against the insides of the first pair of walls.

### BRIEF DESCRIPTION OF THE DRAWINGS

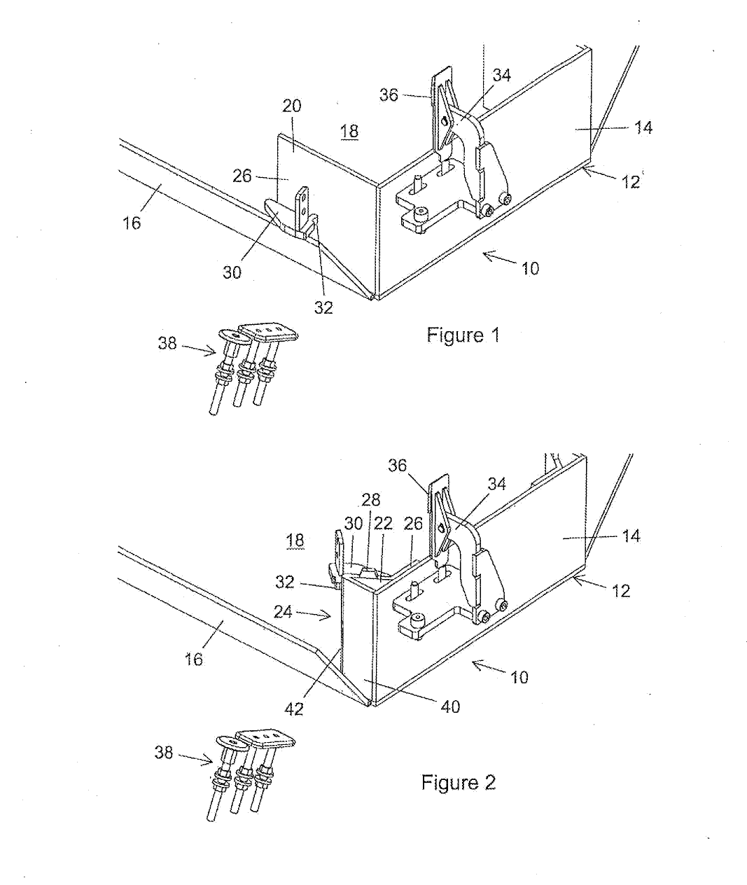

For a better understanding of the present invention, and to show how the same may be carried into effect, the invention will now be described by way of non-limiting example, with reference to the accompanying drawings in which FIGS. 1 to 6 are sequential isometric views of apparatus according to the present invention, in use in erecting part of a container in a method according to the present invention.

### DETAILED DESCRIPTION OF THE DRAWINGS

Referring to the drawings, apparatus in accordance with the present invention is generally indicated by reference numeral 10 and part of a container in the form of a tray is shown during erection of one of its corners and is generally indicated by reference numeral 12.

The container 12 (when erected), includes a first wall or end wall 14 and a second wall or side wall 16 that stand up from edges of a floor 18, with further side and end walls on opposing edges of the floor not shown in the drawings. Extensions 20 on opposing ends of the end wall 14 are folded to form an angled brace 22, which forms part of a triangular pillar 24 in the corner of the container 12. An end 26 of the extension 20 is attached to the inside of the end wall 14 adjacent the pillar 24. In typical embodiments, a stacking tab 28 will be provided that protrudes upwards from the pillar 24, but this is not essential to the present invention and the tab is only shown in FIGS. 2 and 6 and not in the remaining figures.

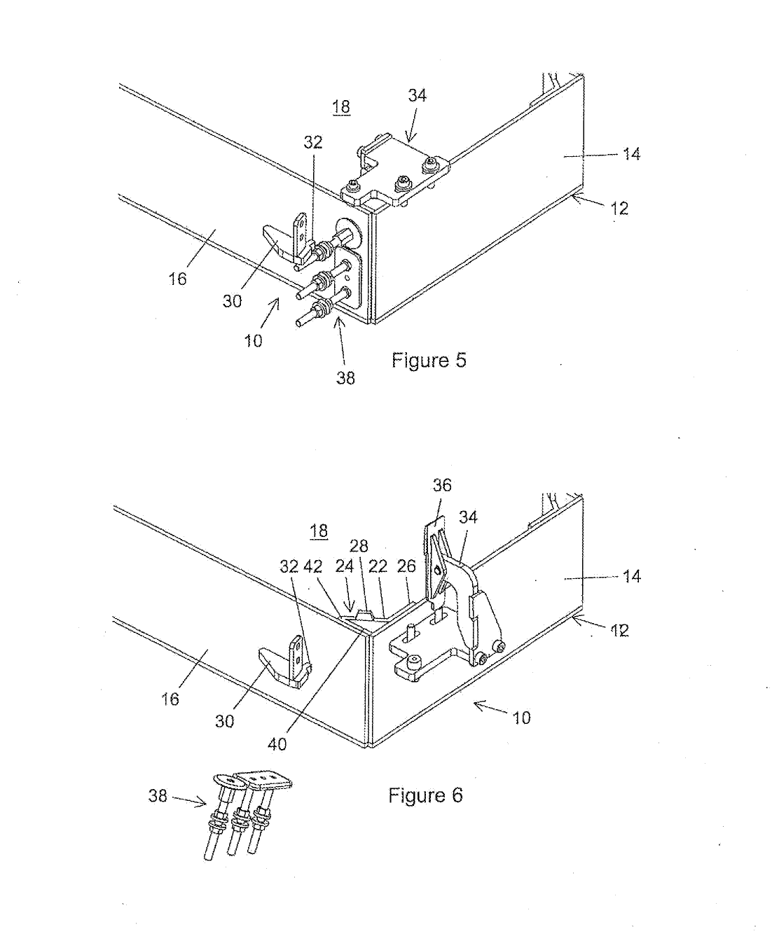

The apparatus 10 includes a mandrel (not shown) that is configured to press a blank from which the container 12 is to be formed between adjacent formations that are spaced from the path of the mandrel in positions where they fold the end walls 14 from positions where they are coplanar with the floor 18 in the container blank, to the upright positions shown in the drawings. Similarly, formations are provided that press the side walls 16 upwards relative to the floor 18. The folding of the end walls 14 by the mandrel and adjacent formations follows a process that is known to those skilled in the art, but the folding of the side walls 16 differs from the known process in that the side walls are not folded to upright positions (as shown in FIGS. 5 and 6), but are folded to substantially lower intermediate positions as shown in FIGS. 1 to 4, in which they slant at acute angles relative to the upright orientation.

The side walls 16 can be folded from a position in which they are coplanar with the floor 18 to their intermediate positions directly, or they can be folded to upright positions and then allowed to return to their intermediate positions under resilience of the sheet material, or other means. In a preferred embodiment, they side walls 16 are folded to upright positions by the mandrel as the partially erected container passes through the adjacent formations, before the side walls are allowed to return to their intermediate positions. In such an embodiment, the container 12 is stable as it moves past the adjacent formations with its side walls 16 and end walls 14 all in upright positions.

The blank for the container 10 is pre-cut, has adhesive pre-applied in locations where required and is scored along fold lines, before the method of the present invention commences.

The apparatus 10 includes fingers 30 that are each configured to pivot horizontally (i.e. parallel to the floor 18) along a pivot path and each finger has a lateral protuberance 32 extending from its edge.

The apparatus 10 also includes arms 34 that are each configured to pivot over the upper edge of the end wall 14 to press a plate 36 outwardly against the inside of the end wall, or other suitable means for pressing outwardly against the inside of the end wall.

The apparatus 10 further includes press elements 38 that are configured to pivot upwards and fold the side walls 16 from: their intermediate position as shown in FIGS. 1 to 4, to their upright position as shown in FIGS. 5 and 6 and to press the ends of the side walls against the pillars 24.

Referring to FIG. 1, when the container 10 is erected, the blank is first formed by the mandrel and adjacent formations as described above, so that the each end wall 14 is in its upright position and each side wall 16 is in its intermediate position. Each of the extensions 20 preferably extends in an upright position, inside the side wall 16. (The positions of the extensions 20 also results from movement of the mandrel relative to adjacent formations as is known to those skilled in the art.) At this stage of the process, each finger 30, arm 34 and press element 38 is in a retracted position.

Referring to FIG. 2, each finger 30 is pivoted above an upper edge of its associated side wall 16, along its pivot path to an inwards position as shown in FIG. 2 and as it is pivoted, it folds its associated extension 20 to form the brace 22 and pillar 24, with the extension end 26 adjacent the inside of the end wall 14. The lateral protuberance 32 of the finger 30 holds an edge 42 of the pillar 24 formed between the brace 22 and a side wall 40 of the pillar, in position and thereby holds the whole pillar in position at this stage. The pillar 24 is formed around a triangular leg of the mandrel, which was still in position up to this stage, but the mandrel's legs are withdrawn upwards from the insides of the pillars 24 at this stage. (The mandrel and its legs have been omitted from the drawings for clarity.) The function of the protuberances 32 in holding the pillars 24 in position prevents distortion of the pillars while the mandrel's legs are withdrawn.

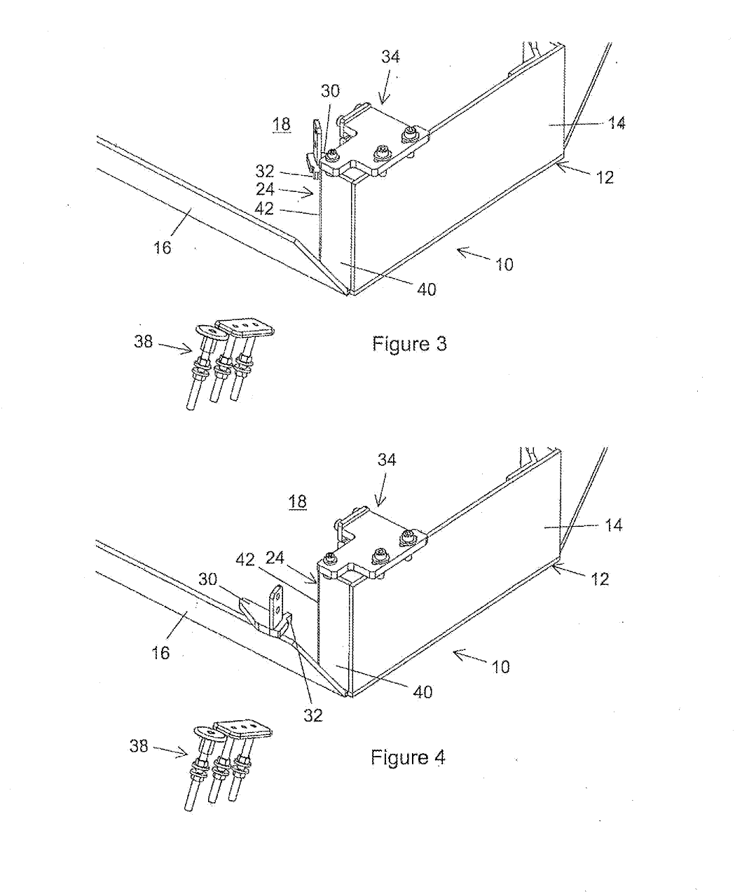

Referring to FIG. 3, while each finger 30 remains in its inwards position, each arm 34 pivots over the upper edge of its associated end wall 14 and its plate 36 presses the extension end 26 against the inside of the end wall to bond adhesively to the end wall. The pillars 24 are thus completely formed at this stage and are held in position by the arms and are being bonded to remain in position.

Referring to FIG. 4, while the arms 34 remain in position and the side walls 16 are still in their intermediate positions, the fingers 30 pivot outwards along their pivot paths over the upper edges of the side wails.

Referring to FIG. 5, the press elements 38 pivot upwards and folds each side wall 16 from its intermediate position to an upright position and presses each end of the side wall inwards against a side wall 40 of a pillar 24 to bond adhesively to the pillar.

Referring to FIG. 6, once the extension ends 26 have bonded sufficiently to the insides of the end walls 14 and the ends of the side walls 16 have bonded sufficiently to the side walls 40 of the pillars 24, the arms 34 and press elements 38 are pivotally returned to their retracted positions and the erection of the container 10 is complete.

As can be seen in the drawings, the height of the side walls 16 equals that of the pillars 24 and end walls 14 and no recess needs to be provided in the side walls to allow space for movement of the fingers 30 when forming the pillars 24.

In the illustrated embodiment, the pillars 24 have triangular cross-sectional profiles, but in some applications, the pillars are required to be kept closer to the insides of the side walls 16 and end walls 14 and they may be folded to form an L-shape, using the method and apparatus 10 described above, with suitable adaptation of the shape of the fingers 30.

1. A method for erecting part of a container, said method comprising:
forming a blank of sheet material;
pressing a part of the blank with a mandrel between adjacent formations to form a floor of the container and upstanding walls on four sides of the floor, a first pair of said upstanding walls being on opposing sides of the floor and being folded to upright positions and the remaining second pair of said upstanding walls being folded from the blank
wherein in that the second pair of said upstanding walls are folded from the blank to slanted intermediate positions that are substantially lower than upright positions;
further characterised by pivoting fingers inwards along pivot paths in directions generally parallel to the floor, above upper edges of the second pair of walls towards inwards positions, to fold extensions on the ends of the first pair of walls to form pillars;
attaching ends of the extensions to the insides of the first pair of walls;
pivoting the fingers outwards; and
folding the second pair of wails to upright positions relative to the floor and pressing them against the outsides of the pillars.

2. A method for erecting part of a container as claimed in claim 1, characterized by pivoting the fingers outwards above upper edges of the second pair of walls.

3. A method for erecting part of a container as claimed in claim 1 or Claim 2, wherein the second pair of walls is folded to their intermediate positions by the mandrel in a single step.

4. A method for erecting part of a container as claimed in claim 1 or claim 2, wherein the second pair of walls is folded by the mandrel to upight_positions and then returned partially to their intermediate positions.

5. A method for erecting part of a container as claimed in claim 1 or claim 2, wherein by attaching the ends of the extensions to the insides of the first pair of walls by pivoting arms over upper edges of the first pair of walls and pressing the ends of the extensions outwardly against the insides of the first pair of walls.

6. A method for erecting part of a container as claimed in claim 1 or claim 2, characterized by heading each pillar in position while its associated finger is in its inward position, by way of a lateral protuberance extending from an edge of the finger.

7. A method for erecting part of a container as claimed in claim 1 or claim 2, wherein the first pair of walls are end walls of the container and the second pair of walls are side walls.

8. A method for erecting part of a container as claimed in claim 1 or claim 2, wherein the ends of the extensions are adhesively bonded against the insides of the first pair of walls.

9. A method for erecting part of a container as claimed in claim 1 or claim 2, wherein the second pair of walls are adhesively bonded against the outsides of the pillars.

10. A method for erecting part of a container as claimed in claim 9, wherein the adhesive is pre-applied to the blank.

11. Apparatus for erecting part of a container, said apparatus including:
a mandrel and adjacent formations between which a container blank can be pressed to form a floor of the container and upstanding walls on four sides of the floor, said upstanding walls including a first pair of opposing walls and a second pair of opposing walls;
fingers that are configured to pivot along pivot paths in directions generally parallel to the container floor towards inwards positions, to fold extensions on the ends of the first pair of walls to form pillars; and
press elements that are configured to fold the second pair of walls to upright positions relative to the floor and pressing them against the outsides of the pillars;
wherein said mandrel and adjacent formations are configured to fold the second pair of walls to slanted intermediate positions substantially lower than upright positions, said intermediate positions being below the pivot paths, and said fingers being configured to pivot outwards along their pivot paths to clear the second walls, before the second walls are folded to their upright position by the press elements.

12. Apparatus for erecting part of a container as claimed in claim 11, wherein each of the fingers have a lateral protuberance extending from an edge of the finger and being configured to hold its associated pillar in position while the finger is in its inwards position.

13. Apparatus for erecting part of a container as claimed in claim 11 or claim 12, wherein said apparatus includes arms that are configured to pivot over upper edges of the first pair of walls to press ends of the extensions outwardly against the insides of the first pair of walls.
